(19) United States
(12) Patent Application Publication
(10) Pub. No.: US 2009/0225095 A1
(43) Pub. Date: Sep. 10, 2009

(54) IMAGE PROCESSING CIRCUIT AND ELECTRONIC APPARATUS HAVING THE SAME CIRCUIT

(75) Inventor: Toshihiro Kojima, Zama-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/395,080

(22) Filed: Feb. 27, 2009

(30) Foreign Application Priority Data
Mar. 4, 2008 (JP) 2008-053046
Feb. 12, 2009 (JP) 2009-029975

(51) Int. Cl. G09G 5/36

(52) U.S. Cl. 345/545

(57) ABSTRACT

A liquid crystal timing controller IC includes: a vertical blanking monitoring circuit that detects a non-display interval, a buffer memory that buffers a look-up table read out from an EEPROM, a look-up table storage that stores the look-up table, an image processor core section that processes images using the look-up table stored in the look-up table storage, and a memory controller that controls transfer of date from the EEPROM to the buffer memory and thereafter controls transfer of data from the buffer memory to the look-up table storage during a non-display interval.

The present application claims a priority based on Japanese Patent Application No. 2008-53046 filed on Mar. 4, 2008 and Japanese Patent Application No. 2009-29975 filed on Feb. 12, 2009, the contents of which are incorporated herein.

### BACKGROUND OF THE INVENTION

1. Field of the Invention

An aspect of the present invention relates to an image processing circuit and an electronic apparatus including the same circuit.

2. Description of Related Art

Liquid crystal devices are recently coming into wide use as display devices that require less space and electricity. Such liquid crystal devices are rapidly gaining in popularity not only as monitors for computers but also as displays for mobile equipment typified by mobile phones and as displays for television receivers. At the same time, advancements in the performance of these liquid crystal devices are remarkable, such that the improved response speed and contrast ratio have led to the appearance of the liquid crystal devices that can be replaced with CRT displays of desktop type computers and workstations.

In recent years, use of large-screen displays and small-size displays as displays for motion pictures (e.g., in televisions) is increasing. If used in televisions, for example, it is required that the liquid crystal devices have high-speed response of the motion picture display, and that they display clear and sharp images.

As regards speeding up of the response of the motion picture display, so-called over-drive compensation is known as drive control of a liquid crystal device to realize high response speed of the liquid crystal.

With respect to display of clear and sharp images with the liquid crystal device, it is often the case that the displayed images look unnatural depending on the screen-viewing angle and the content of a scene in e.g. a cinema. Also, so-called process errors may cause liquid crystal devices of the same model to display video pictures differently. A color correction processing technique is known as a technique to solve these problems. In order to process the color correction, a look-up table is often used.

As a related-art technology, Japanese Patent Publication No. 8-237519 describes a video signal processor which performs video gamma correction by A/D-converting a video signal and using a look-up table. The video signal processor includes: a storage storing in advance correction data for video gamma correction; a clock generator generating a sampling clock for timing the operations of A/D conversion and gamma correction; a phase comparator detecting a difference between a phase of the sampling clock and a phase of a horizontal synchronization signal of a video signal; a frequency divider dividing the sampling clock at a given frequency division ratio, reading out the correction data from the storage, and generating a timing pulse for writing in the look-up table; and a synchronization detector detecting a vertical synchronization signal of a video signal, in that the video signal processor generates the timing pulse for writing in the look-up table using the sampling clock and writes in the correction data in the look-up table during a vertical blanking interval.

According to the technique of Japanese Patent Publication No. 8-237519, it is possible to write the correction data in the look-up table during the vertical blanking interval.

Because the look-up table contains an enormous amount of data, it is common to store the data in an external storage device (e.g., EEPROM) in advance and, when the power is turned on, to read the data from the external storage device into a storage device (e.g., RAM macro) in an image processing circuit. However, it is reported that external stimuli (e.g., static electricity, noise) destroy the look-up table that was read into e.g. the RAM macro in the image processing circuit. Destruction of data in the look-up table causes abnormalities and defects in the image display. Once the data in the look-up table is destroyed, the abnormalities and defects in the image display occur and continue to occur thereafter.

### SUMMARY OF THE INVENTION

The present invention has been designed in view of the technological issues mentioned above. According to some aspects of the invention, it is possible to provide an image processing circuit which allows elimination of the abnormalities and the like in the image display even if the data for image processing was destroyed. Also, according to other aspects, it is possible to provide an electronic apparatus having such an image processing circuit.

One aspect of the invention relates to an image processing circuit which processes images by reading out data stored in an external storage device, the image processing circuit includes: non-display interval detection means that detects a non-display interval which is an interval during which images are not displayed; buffering means that buffers the data read out from the external storage device; storage means that stores the data buffered by the buffering means; image process means that processes images using the data stored in the storage means; and control means that controls the external storage device and the buffering means so as to transfer the data from the external storage device to the buffering means at a given timing or a given time and, thereafter, controls the buffering means and the external storage device so as to transfer the data from the buffering means to the external storage device at a time when the non-display interval detection means detects the non-display interval.

In this case, the data used for image processing may be retransferred from the external storage device. Therefore, even if abnormalities and the like occur in the image display due to destruction of data, the abnormalities and the like may be eliminated. Also, a highly reliable, highly sophisticated, and high-performance electronic apparatus may be provided to customers.

Additionally, in the invention, the non-display interval detection means may detect a vertical blanking interval as the non-display interval, and the control means may control the buffering means and the storage means so as to transfer the data from the buffering means to the storage means at a time when the non-display interval detection means detects the vertical blanking interval as the non-display interval.

As a result, the data can be transferred from the buffering means to the storage means by using the vertical blanking interval as the non-display interval.

Also, in the invention, the non-display interval detection means may detect the vertical blanking interval and/or a horizontal blanking interval as the non-display interval, and the control means may control the buffering means and the storage means so as to transfer the data from the buffering means to the storage means at a time when the non-display interval detection means detects the vertical blanking interval and/or the horizontal blanking interval as the non-display interval.

As a result, the data can be transferred from the buffering means to the storage means by using the vertical blanking interval and/or the horizontal blanking interval as the non-display interval.

Moreover, in the invention, the control means may control the external storage device and the buffering means so as to transfer the data from the external storage device to the buffering means at every given number of frames.

As a result, even if the abnormalities and the like occur in the image display due to destruction of data, the abnormalities and the like can be eliminated at every given number of frames.

Another aspect of the invention relates to an image processing circuit that processes images by using data stored in an external storage device, the image processing circuit includes: first storage means that stores the data read out from the external storage device; second storage means that stores the data read out from the external storage device; first selection means that selectively outputs the data read out from the external storage device to the first storage means or the second storage means; second selection means that selects the data stored in the first storage means or the data stored in the second storage means; image process means that processes images by using the data selected by the second selection means; and control means that controls the external storage device, the first selection means, and the first storage means so as to transfer the data from the external storage device to the first storage means at a given timing or a given time, thereafter controls the second selection means so as to select the data stored in the first storage means, controls the external storage device, the first selection means, and the second storage means so as to transfer the data from the external storage device to the second storage means at a given timing or a given time, and thereafter controls the second selection means so as to select the data stored in the second storage means.

As a result, the data can be transferred alternately to the first and second storage means. As a consequence, even if the amount of data is large and the non-display interval is short, a timing failure can be prevented from occurring.

Also, in the invention, the image processing circuit may further include: buffering means that buffers the data read out from the external storage device, in that the control means: controls the external storage device, the buffering means, the first selection means, and the first storage means so as to transfer the data from the external storage device to the buffering means and to transfer the data from the buffering means to the first storage means at a given timing or a given time; thereafter controls the second selection means so as to select the data stored in the first storage means; controls the external storage device, the buffering means, the first selection means, and the second storage means so as to transfer the data from the external storage device to the buffering means and to transfer the data from the buffering means to the second storage means at a given timing or a given time; and thereafter controls the second selection means so as to transfer the data stored in the second storage means.

As a result, the data can be transferred alternately to the first and second storage means. Accordingly, even if the amount of data is large and the non-display interval is short, the timing failure can be prevented from occurring.

Moreover, in the invention, the image processing circuit may further include: non-display interval detection means that detects a non-display interval which is an interval during which images are not displayed, in that the control means controls the second selection means so as to switch the selection of the data stored in the first storage means or the data stored in the second storage means at a time when the non-display interval detection means detects the non-display interval.

As a result, it is possible to eliminate the possibility of image disturbance associated with the switch of selection by the second selection means.

Also, in the invention, the non-display interval detection means may detect a vertical blanking interval and/or a horizontal blanking interval as the non-display interval, and the control means may control second control means so as to switch the selection of the data stored in the first storage means or the data stored in the second storage means at a time when the non-display interval detection means detects the vertical blanking interval and/or the horizontal blanking interval as the non-display interval.

As a result, the selection by the second selection means can be switched by using the vertical blanking interval and/or the horizontal blanking interval as the non-display interval.

Yet another aspect of the invention relates to an electronic apparatus having the image processing circuit according to the invention.

In this case, the data used for image processing can be retransferred from the external storage device. Accordingly, even if the abnormalities and the like occur in the image display due to destruction of data, they can be eliminated. Also, a highly reliable, highly sophisticated, and high-performance electronic apparatus can be provided to customers.

### BRIEF DESCRIPTION OF THE DRAWINGS

FIG. 1 is a diagram showing a liquid crystal timing controller IC of a comparative example.

FIG. 2 is a flow chart showing an operation of the comparative example.

FIG. 3 is a diagram showing a liquid crystal timing controller IC according to a first embodiment of the invention.

FIG. 4 is a timing chart of the liquid crystal timing controller IC of FIG. 3.

FIG. 5 is a flow chart showing the operation of the liquid crystal timing controller IC of FIG. 3.

FIG. 6 is a diagram showing a liquid crystal timing controller IC according to a second embodiment of the invention.

FIG. 7 is a diagram showing a liquid crystal timing controller IC according to a third embodiment of the invention.

FIG. 8 is a diagram showing a liquid crystal device using the liquid crystal timing controller IC of FIG. 3.

### DETAILED DESCRIPTION OF THE PREFERRED EMBODIMENTS

The embodiments of the invention will now be described in detail. Note that the following descriptions of the embodiments shall not unduly limit the content of the invention as stated in the claims. Also, not all the compositions described in the embodiments are necessarily essential as means of the invention to solve problems. Also, the same elements are allotted the same reference numbers, and descriptions thereof will not be repeated.

### 1. Comparative Example

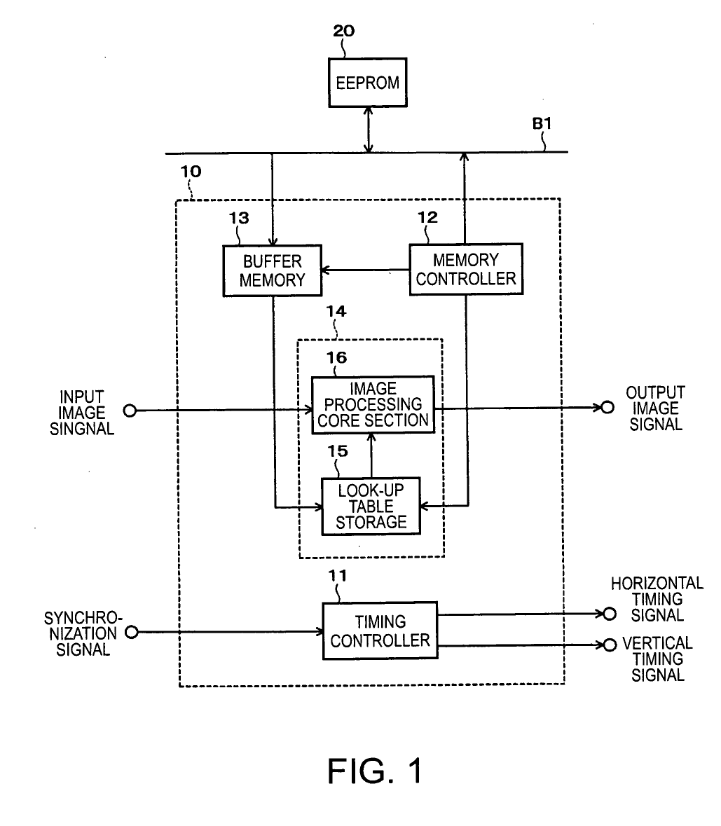

FIG. 1 shows a liquid crystal timing controller IC as a comparison to the present embodiment. This liquid crystal timing controller IC 10 includes a timing controller 11, a memory controller 12, a buffer memory 13, and an image processor IP 14. The image processor IP 14 includes a look-up table storage 15 and an image processor core section 16.

The timing controller 11 receives an input of a synchronization signal (e.g., a dot clock signal, a data enable signal) from a circuit in a preceding stage (not shown), generates a horizontal timing signal and a vertical timing signal, and outputs the signals to circuits in a subsequent stage (not shown).

The memory controller 12 and the buffer memory 13 are coupled to an external EEPROM 20 via a bus B1. The bus B1 may be an inter-integrated circuit (I²C) bus, for example. A look-up table for performing image correction (e.g., color correction, gamma correction) is written in the EEPROM 20 in advance. The operating frequency of the EEPROM 20 is generally about several hundreds kHz and is lower than the operating frequency inside the liquid crystal timing controller 10 (e.g., a dot clock frequency, a multiple of the dot clock frequency). In order to buffer the difference between these operating frequencies, the buffer memory 13 is used in the liquid crystal timing controller IC 10. Reading of data from an EEPROM 20 to a buffer memory 13 and transfer (development) of data from the buffer memory 13 to a look-up table storage 15 are asynchronously conducted. A RAM macro, for example, may be used as the buffer memory 13.

The memory controller 12 outputs to the EEPROM 20 a control signal for reading out data from the EEPROM 20 (hereunder referred to as an “EEPROM read control signal”) via the bus B1 in an initial stage (when power is turned on, when resetting, etc.), while outputting to the buffer memory 13 a control signal for writing data in the buffer memory 13 (hereunder referred to as a “buffer memory write control signal”). As a consequence, the look-up table in the EEPROM 20 is outputted onto the bus B1 and temporarily accumulated in the buffer memory 13.

When the look-up table is accumulated in the buffer memory 13, the memory controller 12 outputs to the buffer memory 13 a control signal for reading out data from the buffer memory 13 (hereunder referred to as a “buffer memory read control signal”), while outputting to the look-up table storage 15 a control signal for writing data in the look-up table storage 15 (hereunder referred to as a “look-up table storage write control signal”). As a consequence, the look-up table accumulated in the buffer memory 13 is transferred (developed) to the look-up table storage 15. As the look-up table storage 15, a RAM macro may be used, for example.

The image processor core section 16 receives an input image signal from a circuit in the preceding stage (not shown). The image processor core section 16 reads data from an address corresponding to a value of the input image signal of the look-up table storage 15 and outputs the read data to a circuit in the subsequent stage (not shown) as an output image signal.

As previously described, it is reported that the data of the look-up table stored in the look-up table storage 15 is destroyed by external stimuli (e.g., static electricity, noise). Destruction of the data in the look-up table causes abnormalities and defects in the image display. Once the data in the look-up table is destroyed, the abnormalities and defects in the image display occur and continue to occur thereafter. In order to eliminate these abnormalities and the like in the image display, it is necessary to reexecute the reading of the look-up table from the EEPROM 20.

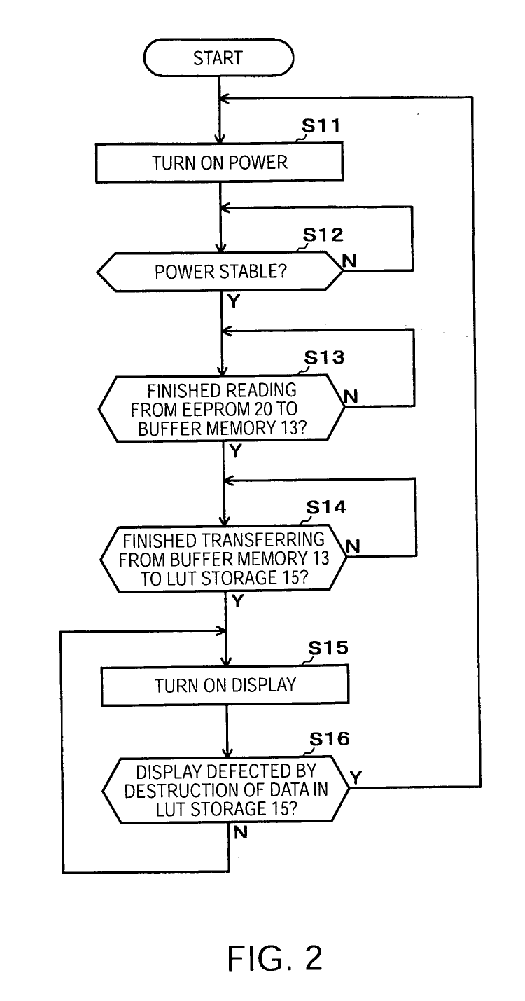

FIG. 2 is a flow chart showing the operation of the liquid crystal timing controller IC 10.

The liquid crystal timing controller IC 10 starts the operation when the power is turned on (step S11) and waits until the power is stabilized (step S12).

Then, the memory controller 12 of the liquid crystal timing controller IC 10 outputs the EEPROM read control signal to the EEPROM 20 via the bus B1 while outputting the buffer memory write control signal to the buffer memory 13, thereby starts reading the look-up table from the EEPROM 20 to the buffer memory 13, and waits until the reading is finished (step S13).

Then, the memory controller 12 of the liquid crystal timing controller IC 10 outputs the buffer memory read control signal to the buffer memory 13 while outputting the look-up table storage write control signal to the look-up table storage 15, turns the look-up table storage 15 into a write mode, transfers (develops) the look-up table from the buffer memory 13 to the look-up table storage 15, and waits until the transfer (development) is finished (step S14).

When the transfer (development) of the look-up table from the buffer memory 13 to the look-up table storage 15 is finished, the image processor core section 16 of the liquid crystal timing controller IC 10 turns on the image display (step S15).

If the abnormalities and the like in the image display did not occur from destruction of the look-up table in the look-up table storage 15, the liquid crystal timing controller IC 10 returns the process to step S15 and continues the display. On the other hand, if the abnormalities and the like in the image display occurred from destruction of the look-up table in the look-up table storage 15, the liquid crystal timing controller IC 10 temporarily turns off the power, reexecutes the process from step S11, and, after turning on the power, reexecutes the reading of the look-up table from the EEPROM 20 (step S16).

As described, in the comparative example, if the look-up table in the look-up table storage 15 is destroyed, it is necessary to temporarily turn off the power, and then to turn on the power and reexecute the reading of the look-up table from the EEPROM 20. However, it is not easy to automatically perform the sequence of determining whether the look-up table in the look-up table storage 15 is destroyed, turning off the power, turning on the power, and reexecuting the reading of the look-up table from the EEPROM 20. In addition, images are not displayed during the periods between on and off of the power and between the rereading of the look-up table from the EEPROM 20 and restarting of the display.

### 2. First Embodiment

### 2.1 Structure

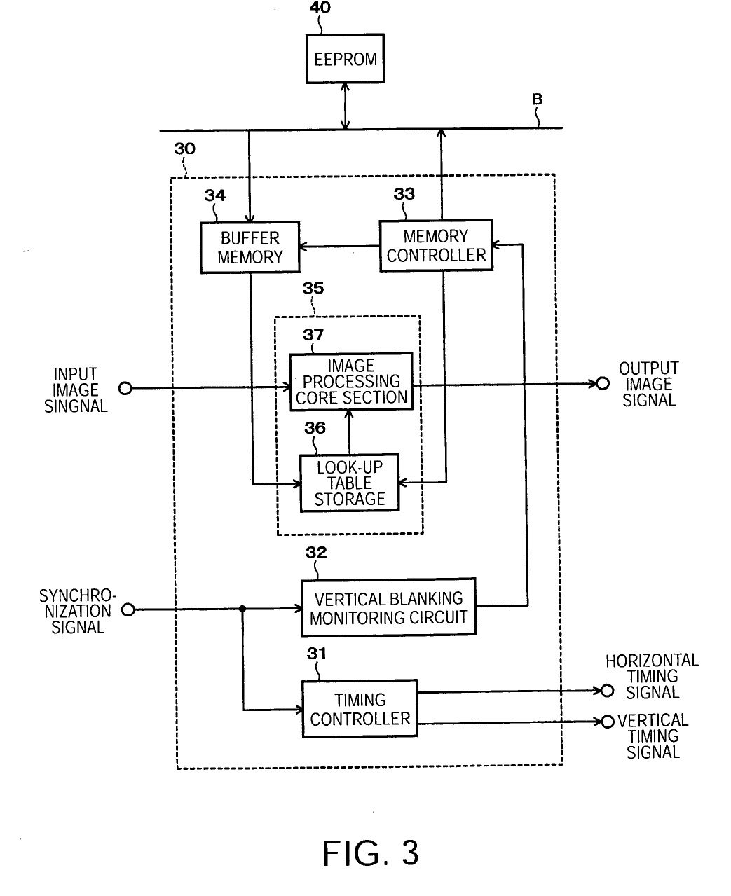

FIG. 3 shows an example of the liquid crystal timing controller IC of the present embodiment that solves the aforementioned problems. The present embodiment is an application of the invention to a liquid crystal timing controller IC.

This liquid crystal timing controller IC 30 includes: a timing controller 31, a vertical blanking monitoring circuit 32 (defined broadly, non-display interval detection means), a memory controller 33 (broadly, control means), a buffer memory 34 (broadly, buffering means), and an image processor IP 35. The image processor IP 35 includes the look-up table storage 36 (broadly, storage means) and an image processor core section 37 (broadly, image process means).

The timing controller 31 receives an input of a synchronization signal (e.g., dot clock signal, data enable signal) from a circuit in the preceding stage (not shown), generates a horizontal timing signal and a vertical timing signal, and outputs the signals to circuits in the subsequent stage (not shown).

Upon receipt of the input of the synchronization signal (e.g., dot clock signal, data enable signal) from the circuit in the preceding stage (not shown), the vertical blanking monitoring circuit 32 monitors a vertical blanking interval as a non-display interval during which images are not displayed, and outputs a control signal indicating the vertical blanking interval (hereunder referred to as a “non-display interval control signal”) to the memory controller 33. Monitoring of the vertical blanking interval is possible through monitoring and counting levels of signals such as the dot clock and data enable signals, for example.

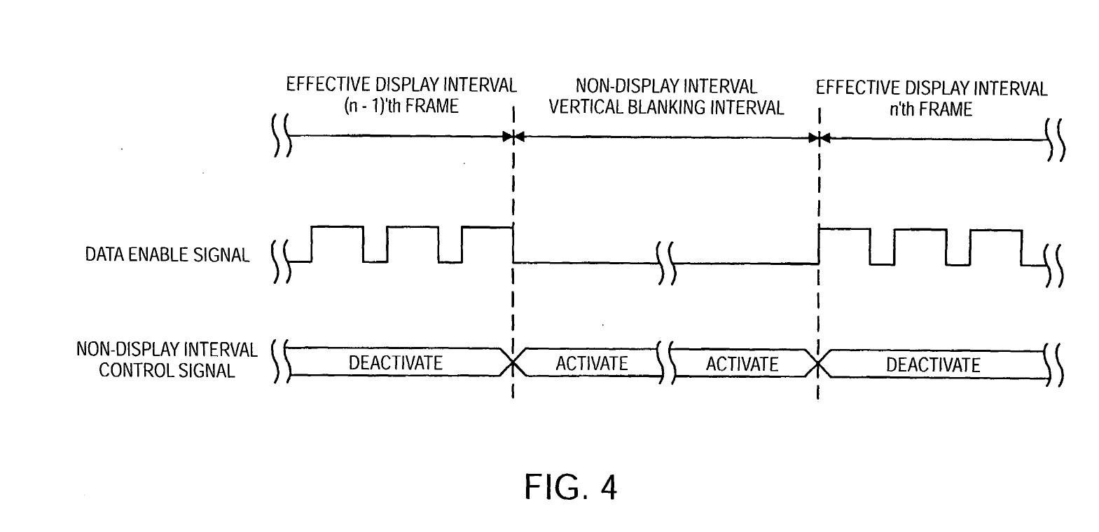

FIG. 4 is a timing chart showing the image display intervals and the vertical blanking interval in the case of using the data enable signal as the synchronization signal. FIG. 4 shows a display interval of the (n−1)th frame, a display interval of the n'th frame, and a vertical blanking interval between these frames.

The level of the data enable signal becomes high during a plurality of intervals for displaying a plurality of lines constituting the (n−1)th and n'th frames and becomes low during intervals (horizontal blanking intervals) between display intervals of certain lines constituting the (n−1)th and n'th frames and display intervals of the next lines and during intervals (the vertical blanking intervals) between the (n−1)th-frame and n'th-frame display intervals. The vertical blanking monitoring circuit 32 deactivates the non-display interval control signal during the (n−1)th- and n'th-frame display intervals and activates the non-display interval control signal during the (n−1)th- and n'th-frame non-display intervals (the vertical blanking intervals).

Also, every time a given number (e.g., 2048) of frames are displayed, the vertical blanking monitoring circuit 32 activates a control signal (hereunder referred to as a “frame number count control signal”) indicating the display of the given number of frames. The given number may be decided depending on frequency or the like of the destruction of data in the look-up table.

Referring again to FIG. 3, the memory controller 33 and the buffer memory 34 are coupled to the external EEPROM 40 via a bus B. An I²C bus may be used as the bus B, for example. A look-up table for performing image correction (e.g., color correction, gamma correction) is written in the EEPROM 40 in advance. The operating frequency of the EEPROM 40 is generally about several hundreds kHz and is lower than the operating frequency (e.g., a dot clock frequency, a multiple of the dot clock frequency) inside the liquid crystal timing controller IC 30. In order to buffer the difference between these operating frequencies, the buffer memory 34 is used in the liquid crystal timing controller IC 30. Reading of data from an EEPROM 40 to the buffer memory 34 and transfer (development) of data from the buffer memory 34 to the look-up table storage 36 are asynchronously conducted. As the buffer memory 34, a RAM macro may be used, for example.

The memory controller 33 outputs to the EEPROM 40 a control signal for reading out data from the EEPROM 40 (hereunder referred to as an “EEPROM read control signal”) via the bus B, while outputting to the buffer memory 34 a control signal for writing data in the buffer memory 34 (hereunder referred to as a “buffer memory write control signal”). As a consequence, the look-up table in the EEPROM 40 is outputted onto the bus B and temporarily accumulated in the buffer memory 34.

When the look-up table is accumulated in the buffer memory 34, the memory controller 33 outputs to the buffer memory 34 a control signal for reading out data from the buffer memory 34 (hereunder referred to as a “buffer memory read control signal”), while outputting to the look-up table storage 36 a control signal for writing data in the look-up table storage 36 (hereunder referred to as a “look-up table storage write control signal”). As a consequence, the look-up table accumulated in the buffer memory 34 is transferred (developed) to the look-up table storage 36. As the look-up table storage 36, a RAM macro may be used, for example.

An input image signal from the circuit in the preceding stage (not shown) is inputted in the image processor core section 37. The image processor core section 37 reads out data from an address corresponding to a value of the input image signal of the look-up table storage 34 and outputs the read data to the circuit in the subsequent stage (not shown) as an output image signal.

### 2.2 Operation

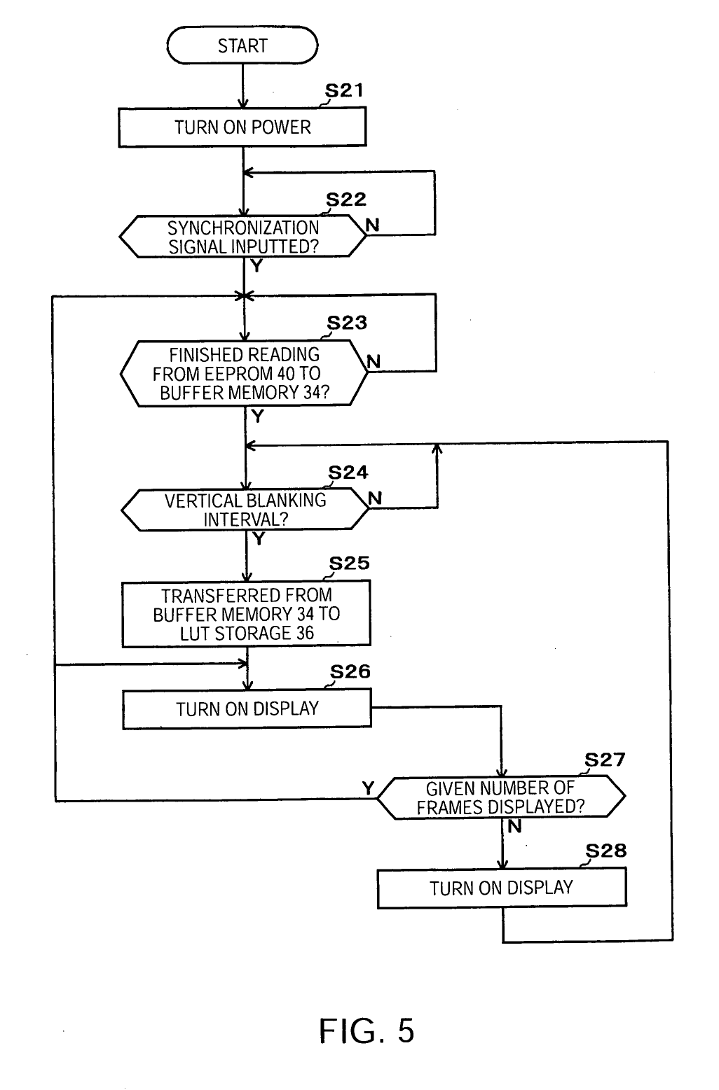

FIG. 5 is a flow chart showing the operation of the liquid crystal timing controller IC 30.

The liquid crystal timing controller IC 30 starts the operation when the power is turned on (step S21) and waits until the synchronization signal and/or the image signal is inputted (step S22).

Then, the memory controller 33 of the liquid crystal timing controller IC 30 outputs the EEPROM read control signal to the EEPROM 40 via the bus B while outputting the buffer memory write control signal to the buffer memory 34, thereby starts reading the look-up table from the EEPROM 40, and waits until the reading is finished (step S23).

Generally, from a cost standpoint, it can be said that a one-port RAM is likely to be used as the look-up table storage 36. In this case, it is not possible to perform the transfer (write access) of the look-up table from the buffer memory 34 to the look-up table storage 36 during the display interval (when the image processor core section 37 is using (read-accessing) the look-up table storage 36 in the read mode).

Thus, the memory controller 33 of the liquid crystal timing controller IC 30 waits until the non-display interval control signal is activated (until the non-display interval (vertical blanking interval)) (step S24). Then, when the non-display interval control signal is activated, the memory controller 33 of the liquid crystal timing controller IC 30 outputs the buffer memory read control signal to the buffer memory 34 while outputting the look-up table storage write control signal to the look-up table storage 36, turns the look-up table storage 36 into a write mode, and transfers (develops) the look-up table from the buffer memory 34 to the look-up table storage 36 (step S25).

When the transfer of the look-up table from the buffer memory 34 to the look-up table storage 36 is finished, the image processor core section 37 of the liquid crystal timing controller IC 30 turns on the image display (step S26).

In contrast, the vertical blanking monitoring circuit 32 of the liquid crystal timing controller IC 30 activates the frame number count control signal every time the given number of frames (e.g., 2048) is displayed. If the frame number count control signal is deactivated (if the given number of frames is not displayed), the liquid crystal timing controller IC 30 returns the process to step S24 while keeping the image display on (step S28).

If the frame number count control signal is activated (if the given number of frames is displayed), the memory controller 33 of the liquid crystal timing controller IC 30 returns the process to step S23, reexecutes the process from step S23, and reexecutes the reading of the look-up table from the EEPROM 40 (step S27). At this point, the image processor core section 37 of the liquid crystal timing controller IC 30 is allowed to return the process to step S26 and keep the image display on (step S27).

After returning the process to step S23, the memory controller 33 of the liquid crystal timing controller IC 30 reads the look-up table from the EEPROM 40 into the buffer memory 34 (step S23) and, when the non-display interval control signal is activated (step S24), transfers (develops) the look-up table from the buffer memory 34 to the look-up table storage 36 (step S25).

As described above, with the liquid crystal timing controller IC 30 according to the embodiment, the look-up table is reread at a given timing (in the embodiment, every time the given number of frames is displayed). As a result, even if the abnormalities and the like occur in the image display from destruction of data in the look-up table in the look-up table storage 15, they can be eliminated. Also, because the look-up table is transferred (developed) from the buffer memory 34 to the look-up table storage 36 during the non-display interval (the vertical blanking interval in the embodiment), the image display is not interrupted. As a result, a highly reliable, highly sophisticated, and high-performance liquid crystal device is provided to the customers.

In this embodiment, although a one-port RAM is used as the look-up table storage 36, a multi-port RAM may be used.

Also, although the look-up table is reread every time the given number of frames is displayed in this embodiment, the look-up table may be reread every time a given length of time passes by using a timer circuit, for example.

Furthermore, although the vertical blanking monitoring circuit 32 counts the display frame number in this embodiment, it may be the memory controller 33 that counts the display frame number.

### 2.3 Modification Example

A modification of the present embodiment will now be described.

In the present embodiment, the vertical blanking monitoring circuit 32 may activate the non-display interval control signal during the vertical blanking interval, or during the horizontal blanking interval (a display interval between a display interval of a certain line (scanning line) constituting a frame and a display interval of the next line (scanning line)) as well as during the vertical blanking interval. Also, in steps S24 and S25, the memory controller 33 may transfer (develop) the look-up table from the buffer memory 34 to the look-up table storage 36 during the vertical blanking interval, or during the horizontal blanking interval as well as during the vertical blanking interval.

Generally, in a liquid crystal device, power is applied, and a backlight is turned on upon finishing the transfer of a look-up table to a storage circuit storing the look-up table, thereby displaying images. However, if the amount of data in the look-up table is enormous, the time it takes from application of power to display of images becomes long, and users often find it uncomfortable. Thus, in order to speed up the transfer of the look-up table from the buffer memory 34 to the look-up table storage 36 at the initial stage, it is preferable to transfer the look-up table from the buffer memory 34 to the look-up table storage 36 during the vertical blanking interval, or during the horizontal blanking as well as during the vertical blanking interval.

Also, as will be described hereunder in detail, the amount of data in the look-up table tends to be increasing in recent years, and a so-called double-speed drive system is employed more often. Thus, while the amount of data in the look-up table increases, if the vertical blanking interval is shortened, a timing failure may possibly occur by transferring the look-up table during the vertical blanking interval. Thus, it is preferable to transfer the look-up table from the buffer memory 34 to the look-up table storage 36 during the horizontal blanking as well as during the vertical blanking interval.

### 3. Second Embodiment

As mentioned previously, a liquid crystal device is increasingly used to display motion pictures (e.g., televisions) in recent years. If a liquid crystal device is used in televisions, for example, it is required to display clear and sharp images, that is, to process the color correction with higher precision. Therefore, the amount of data in the look-up table tends to be increasing.

Moreover, if the liquid crystal device is used in e.g. televisions, the response of the motion picture display needs is required to speed up, and the so-called double-speed drive system is often employed. If the double-speed drive system is employed, the margin of the vertical blanking interval tends to be reduced (the vertical blanking interval is shortened).

Thus, if the vertical blanking interval is shortened while the data amount in the look-up table is increased, the transfer of the look-up table may experience the timing failure in accordance with the first embodiment.

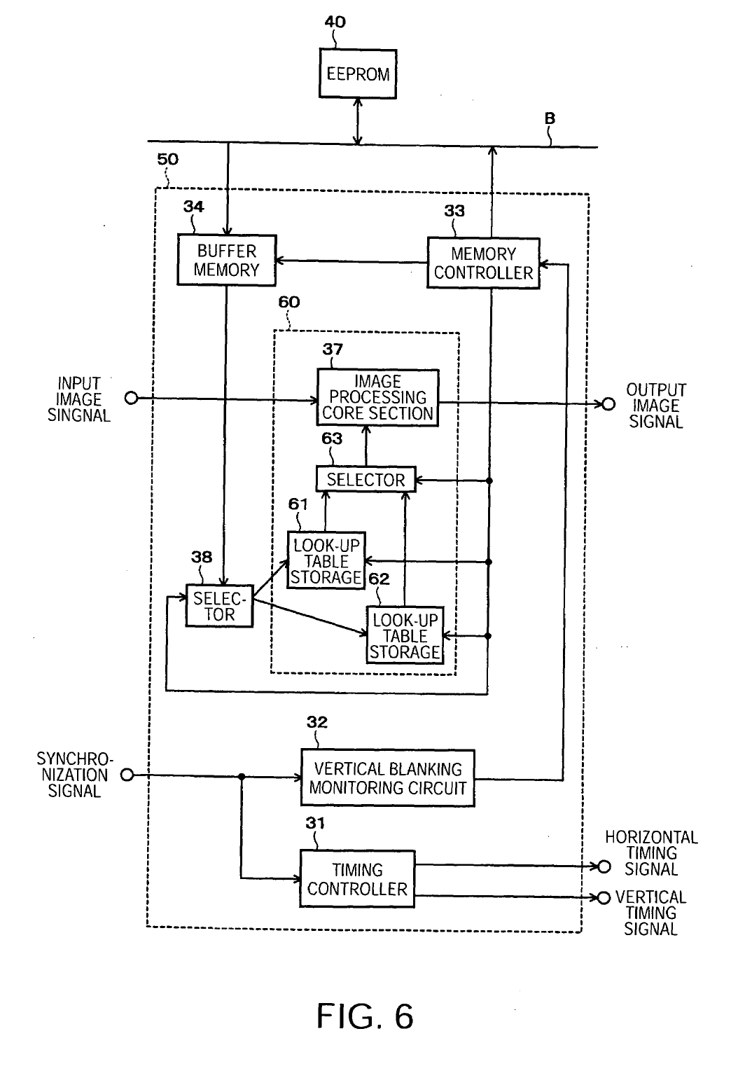

FIG. 6 shows an example of a liquid crystal timing controller IC of the present embodiment that solves these problems. This embodiment is an application of the invention to a liquid crystal timing controller IC.

This liquid crystal timing controller IC 50 includes: the timing controller 31, the vertical blanking monitoring circuit 32 (defined broadly, the non-display interval detection means), the memory controller 33 (broadly, the control means), the buffer memory 34 (broadly, the buffering means), a selector 38 (broadly, first selection means) and an image processor IP 60. The image processor IP 60 includes the image processor core section 37 (broadly, the image process means), a first look-up table storage 61 (broadly, first storage means), a second look-up table storage 61 (broadly, second storage means), and a selector 63 (broadly, second selection means).

The look-up table storages 61, 62 and the selectors 38, 63 are all controlled by control signals from the memory controller 33.

The memory controller 33 first outputs a control signal that turns the look-up table storage 61 into a write mode while outputting a control signal that makes the selectors 38, 63 to select the look-up table storage 61. Then, as in the procedure explained in the first embodiment, the memory controller 33 transfers the look-up table to the look-up table storage 61 by a route from the EEPROM 40, to the buffer memory 34, to the selector 38, and to the look-up table storage 61, and thereafter outputs a control signal that turns the look-up table storage 61 into a read mode. The image processor core section 37 refers to the look-up table in the look-up table storage 61 that is outputted from the selector 63 and processes images.

After the look-up table is transferred to the look-up table storage 61 (at this point, the image processor core section 37 is allowed to perform the image process by using the look-up table in the look-up table storage 61), the memory controller 33 outputs a control signal that turns the look-up table storage 61 into a write mode while outputting a control signal that makes the selectors 38 to select the look-up table storage 62. Then, as in the procedure explained in the first embodiment, the memory controller 33 transfers the look-up table to the look-up table storage 62 by the route from the EEPROM 40, to the buffer memory 34, to the selector 38, and to the look-up table storage 62, and thereafter outputs a control signal that turns the look-up table storage 62 into a read mode.

Then, upon activation of the frame number count control signal outputted from the vertical blanking monitoring circuit 32 (when a given number (e.g., 2048) of frames is displayed), the memory controller 33 outputs a control signal that makes the selector 63 to select the look-up table storage 62. The image processor core section 37 refers to the look-up table in the look-up table storage 62 that is outputted from the selector 63, and processes images.

In addition, it is preferable to perform the switch of selection by the selector 63 while the non-display interval control signal is being activated (during the vertical blanking interval and/or horizontal blanking interval). This reduces the possibility of image disturbance associated with the switch of selection by the selector 63. Also, although there may be a slight image disturbance, the switch of selection by the selector 63 may be conducted at any timing, regardless of the non-display or the display interval, without using the non-display interval control signal.

As described above, after transferring the look-up table to the look-up table storage 62 (at this point, the image processor core section 37 is allowed to process images using the look-up table in the look-up table storage 62), the memory controller 33 transfers the look-up table to the look-up table storage 61 by the route from the EEPROM 40, to the buffer memory 34, to the selector 38, and to the look-up table storage 61.

By repeating the above operations, the memory controller 33 repeats rereading of the look-up table to the look-up table storage 61 and rereading of the look-up table to the look-up table storage 62.

As has been described, the liquid crystal timing controller IC 50 according to the embodiment allows the transfer of the look-up table alternately to the two look-up table storages 61, 62. As a result, even if the amount of date in the look-up table is large and the vertical blanking interval is short, the timing failure is prevented.

In this embodiment, although the vertical blanking monitoring circuit 32 counts the display frame number, it may be the memory controller 33 that counts the display frame number.

Also, although two look-up table storages 61, 62 are included in this embodiment, three or more look-up table storages may be included so as to sequentially transfer the look-up table.

### 4. Third Embodiment

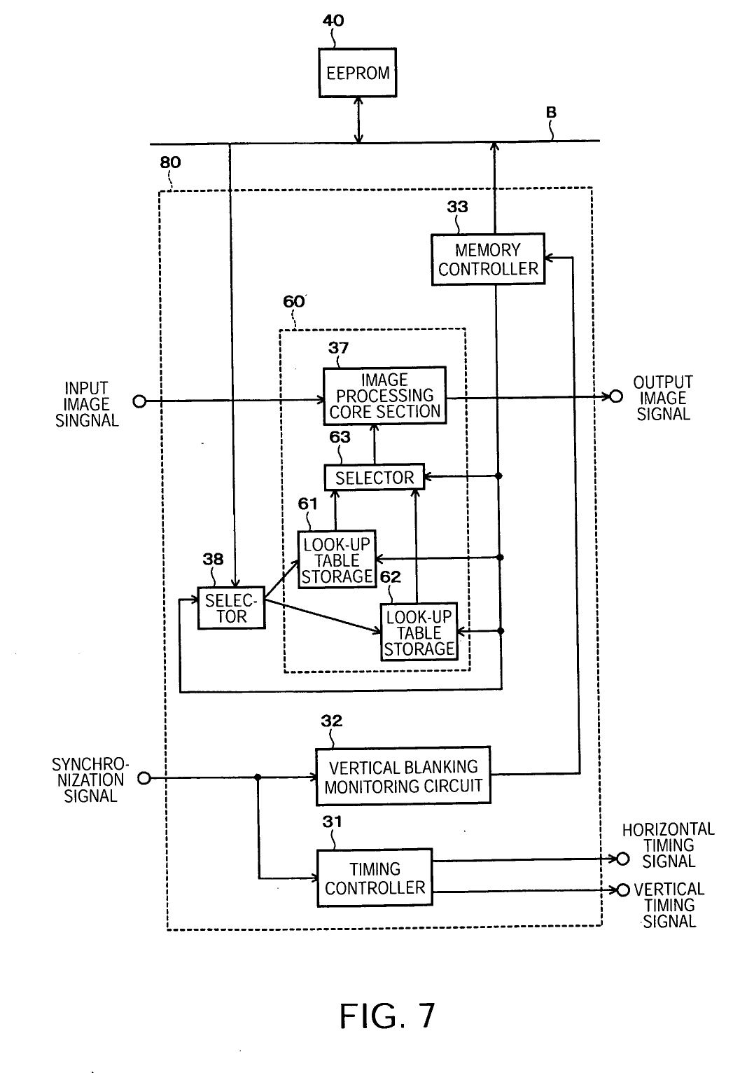

FIG. 7 shows an example of a liquid crystal timing controller IC according to the third embodiment of the invention. The present embodiment is an application of the invention to a liquid crystal timing controller IC.

This liquid crystal timing controller IC 80 includes: the timing controller 31, the vertical blanking monitoring circuit 32, the memory controller 33, the buffer memory 34, the selector 38, and the image processor IP 60. The image processor IP 60 includes the image processor core section 37, the first look-up table storage 61, the second look-up table storage 61, and the selector 63.

Compared to the liquid crystal timing controller IC 50 according to the second embodiment (see FIG. 6), the liquid crystal timing controller IC 80 according to the present embodiment does not include the buffer memory 34.

As in the procedure as previously described, the look-up table is transferred to one of the two look-up table storages 61, 62 and thereafter transferred to the other one of the two look-up table storages 61, 62. At this point, because the image processing can be conducted using one of the two look-up table storages 61, 62, it is not necessary to quickly transfer to the other one of the two look-up table storages 61, 62. Therefore, it is possible to match the speed of writing into the look-up table storages 61, 62 with the speed of reading from the EEPROM 40. Accordingly, as shown in FIG. 7, the buffer memory 34 (see FIG. 6) may be omitted.

### 5. Electronic Apparatus

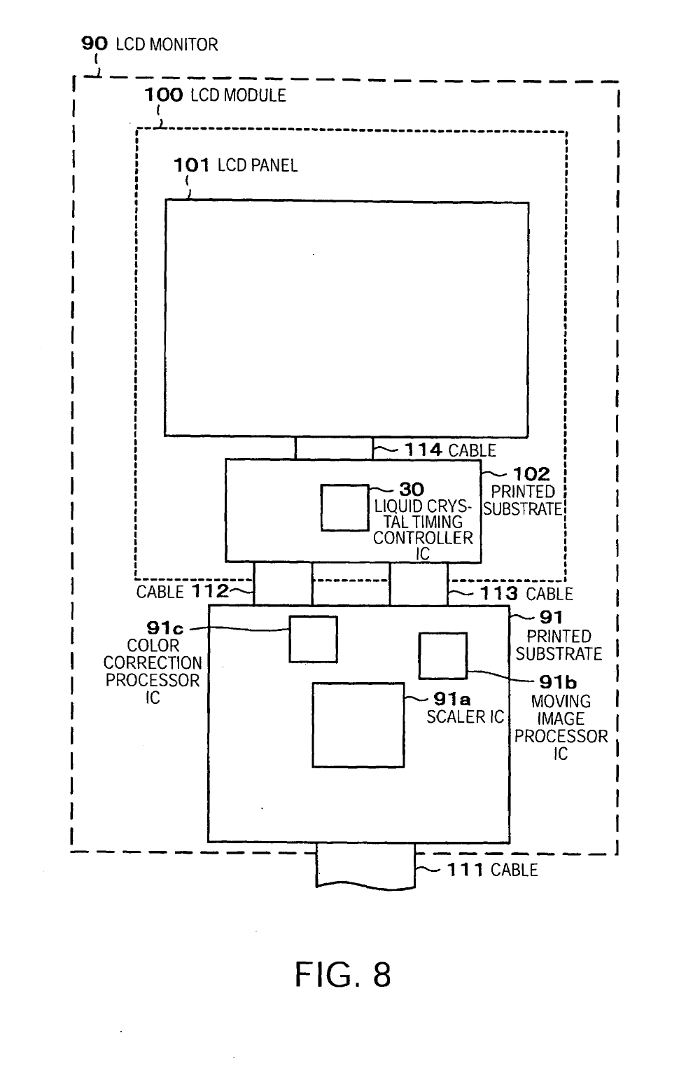

FIG. 8 is a diagram showing an example of an electronic apparatus (an LCD monitor in this case) using the liquid crystal timing controller IC 30 of the embodiment of the invention.

An LCD monitor 90 includes a printed substrate 91 and an LCD module 100.

Mounted on the printed substrate 91 are a scaler IC 91a, a moving image processor IP 91b that carries out a process for improving appearance of the moving images, and a color correction processor IC 91c that carries out a process for improving color development.

The LCD module 100 includes an LCD panel 101 and a printed substrate 102.

The printed substrate 102 has the liquid crystal timing controller IC 30 mounted thereon.

The LCD panel 101 is coupled to the printed substrate 102 via a cable 114; the printed substrate 102 is coupled to the printed substrate 91 via cables 112, 113; and the printed substrate 91 is coupled to an external apparatus (not shown) via a cable 111.

As thus shown, the liquid crystal timing controller IC according to the embodiments may be used in the LCD module and the LCD monitor.

The embodiments have now been described in detail. However, it may be easily understood by those skilled in the art that a number of modifications are possible insofar as they do not deviate from the new matters and effects of the invention. Accordingly, all such modifications are to be included in the scope of the invention. For example, in the specification or the drawings, a term described at least once with a different term having the same or a broader meaning may be replaced with that different term described anywhere in the specification or the drawings. The invention may be used in color correction circuits, gamma correction circuits, and other image processing circuits. Additionally, the control sequence, the number of storage means, port configuration of RAM, external storage devices, etc. may also not be limited to those mentioned in the embodiments, and all sorts of modifications may be made thereto.

1. An image processing circuit that processes images by reading out data stored in an external storage device, the image processing circuit comprising:
non-display interval detection means that detects a non-display interval which is an interval during which images are not displayed;
buffering means that buffers the data read out from the external storage device;
storage means that stores the data buffered by the buffering means;
image process means that processes images using the data stored in the storage means; and
control means that controls the external storage device and the buffering means so as to transfer the data from the external storage device to the buffering means at a given timing or a given time and, thereafter, controls the buffering means and the external storage device so as to transfer the data from the buffering means to the external storage device at a time when the non-display interval detection means detects the non-display interval.

2. The image processing circuit according to claim 1, wherein:
the non-display interval detection means detects a vertical blanking interval as the non-display interval; and
the control means controls the buffering means and the storage means so as to transfer the data from the buffering means to the storage means at a time when the non-display interval detection means detects the vertical blanking interval as the non-display interval.

3. The image processing circuit according to claim 1, wherein:
the non-display interval detection means detects the vertical blanking interval and/or a horizontal blanking interval as the non-display interval; and
the control means controls the buffering means and the storage means so as to transfer the data from the buffering means to the storage means at a time when the non-display interval detection means detects at least one of the vertical blanking interval and the horizontal blanking interval as the non-display interval.

4. The image processing circuit according to claim 1, wherein:
the control means controls the external storage device and the buffering means so as to transfer the data from the external storage device to the buffering means at every given number of frames.

5. An image processing circuit that processes images by using data stored in an external storage device, the image processing circuit comprising:
first storage means that stores the data read out from the external storage device;
second storage means that stores the data read out from the external storage device;
first selection means that selectively outputs the data read out from the external storage device to the first storage means or the second storage means;
second selection means that selects the data stored in the first storage means or the data stored in the second storage means;
image process means that processes images by using the data selected by the second selection means; and
control means that controls the external storage device, the first selection means, and the first storage means so as to transfer the data from the external storage device to the first storage means at a given timing or a given time, thereafter controls the second selection means so as to select the data stored in the first storage means, controls the external storage device, the first selection means, and the second storage means so as to transfer the data from the external storage device to the second storage means at a given timing or a given time, and thereafter controls the second selection means so as to select the data stored in the second storage means.

6. The image processing circuit according to claim 5, further comprising:
buffering means that buffers the data read out from the external storage device, wherein
the control means: controls the external storage device, the buffering means, the first selection means, and the first storage means so as to transfer the data from the external storage device to the buffering means and to transfer the data from the buffering means to the first storage means at a given timing or a given time; thereafter controls the second selection means so as to select the data stored in the first storage means; controls the external storage device, the buffering means, the first selection means, and the second storage means so as to transfer the data from the external storage device to the buffering means and to transfer the data from the buffering means to the second storage means at a given timing or a given time; and thereafter controls the second selection means so as to transfer the data stored in the second storage means.

7. The image processing circuit according to claim 5, further comprising:
non-display interval detection means that detects a non-display interval which is an interval during which images are not displayed, wherein
the control means controls the second selection means so as to switch the selection of the data stored in the first storage means or the data stored in the second storage means at a time when the non-display interval detection means detects the non-display interval.

8. The image processing circuit according to claim 7, wherein:
the non-display interval detection means detects a vertical blanking interval and/or a horizontal blanking interval as the non-display interval; and
the control means controls the second control means so as to switch the selection of the data stored in the first storage means or the data stored in the second storage means at a time when the non-display interval detection means detects at least one of the vertical blanking interval and the horizontal blanking interval as the non-display interval.

9. An electronic apparatus including the image processing circuit according to claim 1.

10. An electronic apparatus including the image processing circuit according to claim 5.
